(19) United States
(12) Patent Application Publication
(10) Pub. No.: US 2005/0144056 A1
(43) Pub. Date: Jun. 30, 2005

(54) Systems and methods for capacity reservation

(76) Inventors: Chung-Wen Wang, Hsinchu City (TW); Yi-Chin Hsu, Taipei City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/747,726

(22) Filed: Dec. 29, 2003

(51) Int. Cl. G06F 17/60

(52) U.S. Cl. 705/8

(57) ABSTRACT

A method of capacity reservation. The inventive method first obtains historical customer delivery data, classifies the customers into different category levels according to the delivery data, and reserves capacity for the customer categories accordingly.

### BACKGROUND OF THE INVENTION

1. Field of the Invention

The present invention relates to a capacity reservation scheme, and in particular to systems and methods for capacity reservation based on historical customer delivery data.

2. Description of the Related Art

In a demand based production model, customers provide orders to manufacturers in accordance with preferred product, quantity, and delivery date. Manufacturers respond by manufacturing desired products in the preferred quantities with enough lead time to ship the products such that they arrive on or before the target delivery date. A demand based production model is reactive, difficult to manage, and ignores production capacity which may be insufficient to meet customer demand. This is especially true in high technology manufacturing, such as, integrated circuit (IC) manufacturing where optimizing production capacity is critical for foundry operation. One conventional approach to remedy the problems associated with the demand production model is to ask current customers to provide forecasted demands. Manufacturers, in turn, use the forecasted demands to produce a corresponding capacity management plan.

In capacity management planning, calculating an Available To Promise (ATP) production capacity is an important task. The more accurate the estimated ATP amount, the more accurate the capacity management plan. Present and conventional methods for estimating ATP capacity are based on forecast demand data. Thus, ATP capacity cannot be allocated according to individual customers, for example, those with a fixed delivery time or distributed delivery time requirements.

From a service aspect, the disclosed methods for allocating ATP capacity fail to consider customer differences. From a management aspect, because a working capacity management policy must fulfill customer requests and capacity arrangements equally, manufacturers may update order commit dates manually for capacity arrangement, causing deviation in a capacity profile and foundry execution. Production rates greater than a desirable production rate for prolonged periods can lead to unintended degradation in product quality.

U.S. Pat. No. 6,188,989 discloses a system and method for managing ATP product. The system and method automatically manages ATP stock and commits to fulfilling customer requests there from. In addition, U.S. Pat. No. 6,167,380 discloses a system and method for allocating manufactured product sellers. The system and method also manage ATP stock and commit to fulfilling customer requests. The disclosed methods consider order data and product data, but do not consider information related to customers. The methods are not well suited for high technology manufacturers with complex manufacturing processes and capacity management planning, such as IC manufacturing.

### SUMMARY OF THE INVENTION

Accordingly, an object of the invention is to provide systems and methods for capacity reservation based on historical customer delivery data. Through the reserved capacity, orders can be fulfilled after submission and the manufacturer can arrange capacity according to the manufacturing needs.

To achieve the foregoing and other objects, the invention is directed to novel systems and methods for overcoming conventional capacity reservation deviation problems. Historical customer delivery data is acquired, customers are classified according to their delivery time requirements, and production capacity is reserved for the customers. The delivery time requirements comprise fixed delivery time requirements, distributed delivery time requirements, and floating delivery time requirements.

### BRIEF DESCRIPTION OF THE DRAWINGS

The present invention can be more fully understood by reading the subsequent detailed description and example embodiments with references to the accompanying drawings, wherein:

FIG. 1 is a flowchart illustrating an embodiment of the method for capacity reservation based on historical customer delivery data;

FIG. 2 is a flowchart illustrating customer classification within the method of FIG. 1;

FIG. 3 is a flowchart illustrating capacity reservation within the method of FIG. 1;

FIG. 4 is a diagram illustrating an embodiment of a storage medium for storing a computer program capable of implementing the method of FIG. 1;

FIG. 5 is a diagram illustrating an embodiment of a system capable of implementing a capacity reservation scheme based on historical customer delivery data.

### DETAILED DESCRIPTION OF THE INVENTION

As summarized above, the present invention is directed to novel systems and methods for overcoming conventional capacity reservation deviation problems. In one embodiment, historical customer delivery data is acquired, including delivery time requirements corresponding to each customer. The delivery time requirements may comprise fixed delivery time requirements, distributed delivery time requirements, and floating delivery time requirements. Fixed delivery time requirements are generated when the customer requires products delivered on a fixed date. Distributed delivery time requirements are generated when the customer requires products delivered on regularly distributed dates, such as every Monday. Floating delivery time requirements are generated when the customer has no fixed delivery time requirement.

Next, customers are classified into different delivery category levels according to the historical customer delivery data. In particular, customers with fixed delivery time requirements are designated as first category customers. Customers with distributed delivery time requirements are designated as second category customers, and customers with floating delivery time requirements are designated as third category customers.

Finally, production capacity is reserved in a production plan for the customers in accordance with the delivery priorities. More particularly, production capacity is reserved for first category production capacity is allocated to first category customers and a remaining portion of the capacity, designated as a first remaining capacity is calculated. The first remaining capacity is allocated among the second category customers, and a remaining portion of the first remaining capacity, designated as a second remaining capacity is calculated. The second remaining capacity is then allocated among the third category customers.

Establishing capacity reservation using customers' historical delivery data, prior to receiving actual customer orders, produces an accurate ATP capacity estimate for production capacity management.

In addition, the invention discloses a storage medium for storing a computer program including executable instructions that implement a method of capacity reservation based on historical customer delivery data, including the steps disclosed.

Furthermore, the invention discloses a system of capacity reservation based on historical customer delivery data. The system includes a customer interface, a customer database, and a controller computer.

The customer interface inputs historical customer delivery data. In one embodiment, the historical customer delivery data comprises delivery time requirements corresponding to each customer, further comprising fixed delivery time requirements, distributed delivery time requirements, and floating delivery time requirements. The customer database stores the historical customer delivery data of the customers.

The controller computer is coupled to the customer interface and the customer database. The controller computer classifies the customers into different priorities according to the historical customer delivery data and reserves capacity for the customers accordingly.

Here, the disclosed classification can be accomplished by several designations. The controller computer designates customers with fixed delivery time requirements as first category customers, designates customers with distributed delivery time requirements as second category customers, and designates customers with floating delivery time requirements as third category customers.

The disclosed capacity reservation is accomplished by certain detailed steps. The controller computer reserves capacity for the first category customers, and calculates a remaining portion of the capacity, designated as a first remaining capacity. The controller computer reserves the first remaining capacity for the second category customers, and calculates a remaining portion of the first remaining capacity, designated as a second remaining capacity. The controller computer reserves the second remaining capacity for the third category customers.

Moreover, the invention discloses a system of demand and capacity management. The system includes an allocation planning module, a capacity model, and a capacity management module. The allocation planning module receives a demand plan for a product from a participating customer. The capacity model has route information for the product, wherein the route information records tools. The capacity management module reserves capacity according to the demand plan.

The capacity management module further comprises a data input module, a classification module, and a reservation module. The data input module inputs historical customer delivery data. The classification module classifies the customers into different priorities according to the historical customer delivery data. The reservation module reserves capacity for the customers accordingly.

The classification module further comprises a first designation module, a second designation module, and a third designation module. The first designation module designates customers with fixed delivery time requirements as first category customers, the second designation module designates customers with distributed delivery time requirements as second category customers, and the third designation module designates customers with floating delivery time requirements as third category customers.

The reservation module further comprises a first reservation module, a first calculation module, a second reservation module, a second calculation module, and a third reservation module. The first reservation module reserves capacity for the first category customers. The first calculation module calculates a remaining portion of the capacity designated as a first remaining capacity. The second reservation module reserves the first remaining capacity for the second category customers. The second calculation module calculates a remaining portion of the first remaining capacity designated as a second remaining capacity. The third reservation module reserves the second remaining capacity for the third category customers.

The system can be applied to support supply chain management for a manufacturer. The capacity management module handles capacity arrangement, both before and after ordering. As an example, the result obtained by the capacity management module may be distributed to the foundries for manufacturing.

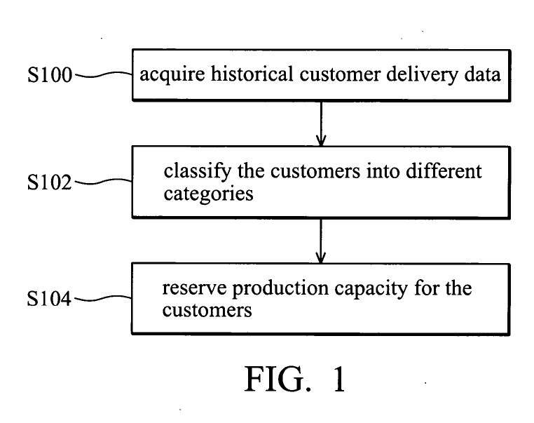

FIG. 1 is a flowchart of the method for capacity reservation based on historical customer delivery data. First, historical customer delivery data is input (step S100), and can include delivery time requirements corresponding to each customer. The delivery time requirements comprise fixed delivery time requirements, distributed delivery time requirements, and floating delivery time requirements.

Next, the customers are classified into different category levels according to the historical customer delivery data (step S102). Finally, capacity is reserved for the customers in accordance with the assigned category levels (Step S104).

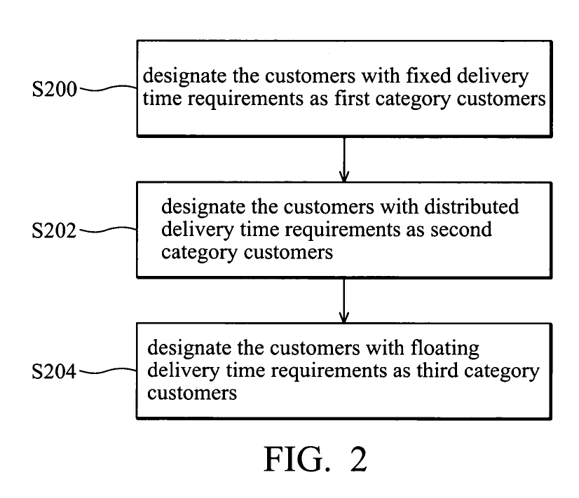

FIG. 2 is a flowchart illustrating classification of customers based on historical customer delivery data. First, the customers corresponding to the fixed delivery time requirements are designated as first category customers (step S200). The customers corresponding to the distributed delivery time requirements are then designated as second category customers (step S202). Finally, the customers corresponding to the floating delivery time requirements are designated as third category customers (step S204).

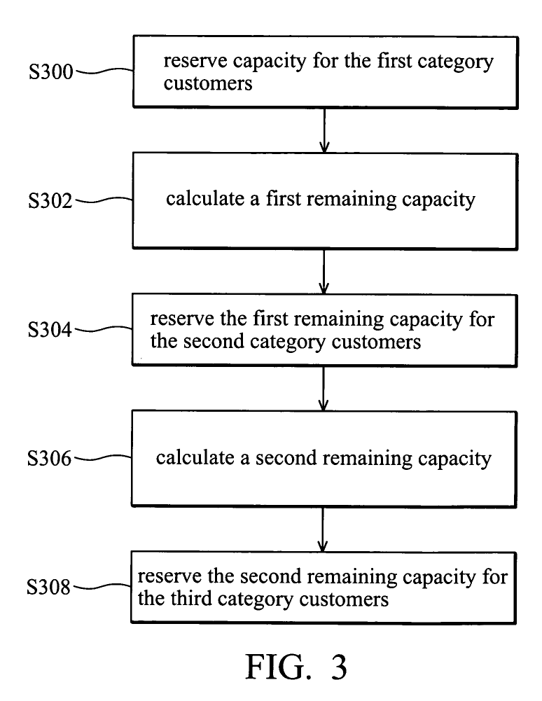

FIG. 3 is a flowchart illustrating production capacity reservation based on historical customer delivery data. Capacity is reserved for the first category customers (step S300), and a remaining portion of the capacity designated as a first remaining capacity is calculated (step S302). The first remaining capacity is reserved for the second category customers (step S304), and a remaining portion of the first remaining capacity, designated as a second remaining capacity is calculated (step S306). The second remaining capacity is reserved for the third category customers (step S308).

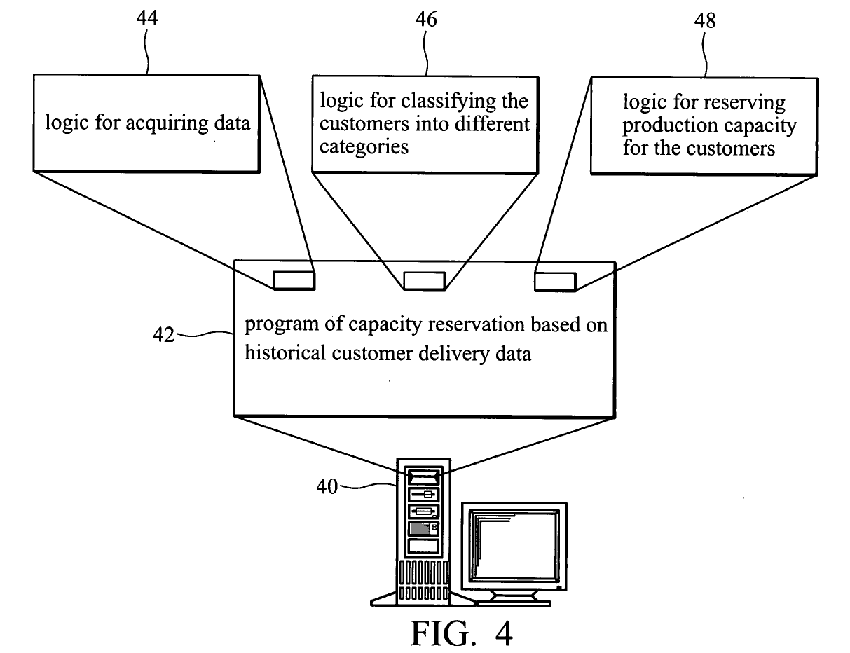

FIG. 4 is a diagram illustrating an embodiment of a storage medium for storing a computer program comprising executable instructions for providing a method of capacity reservation based on historical customer delivery data. The storage medium 40 stores a computer program 42. The computer program 42 provides a method of capacity reservation based on historical customer delivery data. The computer program 42 includes logic for inputting data 44, logic for classifying the customers into different categories 46, and logic for reserving production capacity for the customers 48.

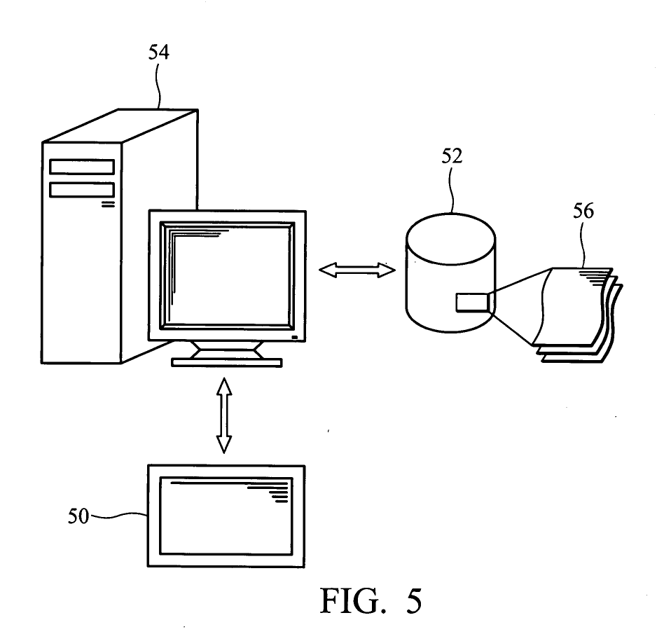

FIG. 5 is a diagram illustrating an embodiment of a system capable of reserving production capacity based on historical customer delivery data. The system includes a customer interface 50, a customer database 52, and a controller computer 54.

The customer interface 50 receives or otherwise acquires historical customer delivery data. In one embodiment, the historical customer delivery data comprises delivery time requirements corresponding to each customer. The delivery time requirements may include fixed delivery time requirements, distributed delivery time requirements, and floating delivery time requirements.

The customer database 52 stores the historical customer delivery data of the customers 56. While the system illustrated in FIG. 5 indicates that the historical delivery data of the customers 56 is inserted directly into the customer database 52, those skilled in the art should understand that the historical customer delivery data 56 may be entered manually via customer interface 50 or automatically via controller computer 50 or other devices coupled to the system.

The controller computer 54 is coupled to the customer interface 50 and the customer database 52. The controller computer 50 classifies the customers into different priorities according to the historical customer delivery data 56 and reserves capacity for the customers accordingly.

Here, classification can be accomplished by associated certain designators with each customer. That is, associating customers with fixed delivery time requirements as first category customers, associating customers with distributed delivery time requirements as second category customers, and associating customers with floating (i.e., flexible) delivery time requirements as third category customers.

Reserving production capacity comprises certain detailed steps. The controller computer 54 reserves capacity for the first category customers. The controller computer 54 calculates a remaining portion of the capacity designated as a first remaining capacity. The controller computer 54 reserves the first remaining capacity for the second category customers. The controller computer 54 calculates a remaining portion of the first remaining capacity designated as a second remaining capacity. The controller computer 54 reserves the second remaining capacity for the third category customers.

Thus, a method of capacity reservation based on historical customer delivery data is provided by the invention. The disclosed method utilizes the customers' historical delivery data to classify the customers into different category levels and reserves production capacity according to the category levels, thereby solving the conventional problems attributed to a demand production model. The inventive method is specifically useful in high technology-related fields, such as IC manufacturing, as it presents significant advantages in capacity reservation.

It will be appreciated from the foregoing description that the systems and methods described herein provide a dynamic and robust solution to the capacity reservation problem. If, for example, a customer changes delivery behavior, the systems and methods of the present invention can revise the category of the customer to fit the customers' new delivery preference.

The systems and methods of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it should be understood that the invention is not limited to the disclosed embodiments. To the contrary, it is intended to cover various modifications and similar arrangements (as would be apparent to those skilled in the art). Thus, the scope of the appended claims should be accorded the broadest interpretation so as to encompass all such modifications and similar arrangements.

1. A method for capacity reservation based on historical customer delivery data, comprising the steps of:
acquiring historical customer delivery data of a plurality of customers;
classifying the customers into a plurality of different categories according to the historical customer delivery data; and
reserving production capacity for the customers in accordance with the different categories.

2. The method as claimed in claim 1, wherein the historical customer delivery data comprises delivery time requirements corresponding to each customer.

3. The method as claimed in claim 2, wherein the delivery time requirements comprise requirements selected from the group consisting of fixed delivery time requirements, distributed delivery time requirements, and floating delivery time requirements.

4. The method as claimed in claim 1, wherein classification further comprises:
designating customers with fixed delivery time requirements as first category customers;
designating customers with distributed delivery time requirements as second category customers; and
designating customers with floating delivery time requirements as third category customers.

5. The method as claimed in claim 1, wherein reservation further comprises:
reserving capacity for the first category customers;
calculating a first remaining capacity;
reserving the first remaining capacity for the second category customers;
calculating a second remaining capacity; and
reserving the second remaining capacity for the third category customers.

6. A storage medium for storing a computer program providing a method of capacity reservation based on historical customer delivery data, the method comprising the steps of:
acquiring historical customer delivery data of a plurality of customers;
classifying the customers into a plurality of different categories according to the historical customer delivery data; and
reserving production capacity for the customers in accordance with the different categories.

7. The storage medium as claimed in claim 6, wherein the historical customer delivery data comprises a plurality of delivery time requirements.

8. The storage medium as claimed in claim 7, wherein the delivery time requirements further comprise requirements selected from the group consisting of fixed delivery time requirements, distributed delivery time requirements, and floating delivery time requirements.

9. The storage medium as claimed in claim 6, wherein classification further comprises:
designating customers with fixed delivery time requirements as first category customers;
designating customers with distributed delivery time requirements as second category customers; and
designating customers with floating delivery time requirements as third category customers.

10. The storage medium as claimed in claim 6, wherein reservation further comprises:
reserving capacity for the first category customers;
calculating a first remaining capacity;
reserving the first remaining capacity for the second category customers;
calculating a second remaining capacity; and
reserving the second remaining capacity for the third category customers.

11. A system of capacity reservation based on historical customer delivery data, comprising:
a customer interface configured to acquire historical customer delivery data of a plurality of customers;
a customer database configured to store the historical customer delivery data of the customers;
a controller computer, coupled to the customer interface and the customer database, the controller computer configured to classify the customers into a plurality of different categories according to the historical customer delivery data and reserving production capacity in accordance with the categories.

12. The system as claimed in claim 11, wherein the historical customer delivery data comprises a plurality of delivery time requirements.

13. The system as claimed in claim 12, wherein the delivery time requirements further comprise requirements selected from the group consisting of fixed delivery time requirements, distributed delivery time requirements, and floating delivery time requirements.

14. The system as claimed in claim 1, wherein the controller computer further designates customers with fixed delivery time requirements as first category customers, designates customers with distributed delivery time requirements as second category customers, and designates customers with floating delivery time requirements as third category customers.

15. The system as claimed in claim 11, wherein the controller computer further reserves capacity for the first category customers, and calculates a first remaining capacity, reserves the first remaining capacity for the second category customers, and calculates a second remaining capacity, and reserves the second remaining capacity for the third category customers.

16. A system of demand and capacity management, comprising:
an allocation planning module configured to receive a demand plan for a product from a participating customer;
a capacity model having route information for the product, wherein the route information records a plurality of tools; and
a capacity management module configured to reserve capacity according to the demand plan.

17. The system as claimed in claim 16, wherein the capacity management module further comprises:
a data input module, configured to acquire historical customer delivery data of a plurality of customers;
a classification module, configured to classify the customer into a plurality of different categories according to the historical customer delivery data; and
a reservation module, configured to reserve capacity for the customers in accordance with the different categories.

18. The system as claimed in claim 17, wherein the historical customer delivery data comprises a plurality of delivery time requirements.

19. The system as claimed in claim 18, wherein the delivery time requirements further comprise requirements selected from the group consisting of fixed delivery time requirements, distributed delivery time requirements, and floating delivery time requirements.

20. The system as claimed in claim 17, wherein the classification module further comprises:
a first designation module, configured to designate customers with fixed delivery time requirements as first category customers;
a second designation module, configured to designate customers with distributed delivery time requirements as second category customers; and
a third designation module, configured to designate customers with floating delivery time requirements as third category customers.

21. The system as claimed in claim 17, wherein the reservation module further comprises:
a first reservation module, configured to reserve capacity for the first category customers;
a first calculation module, configured to calculate a first remaining capacity;
a second reservation module, configured to reserve the first remaining capacity for the second category customers;
a second calculation module, configured to calculate a second remaining capacity; and
a third reservation module, configured to reserve the second remaining capacity for the third category customers.
